(19) United States
(12) Patent Application Publication
(10) Pub. No.: US 2025/0175376 A1
(43) Pub. Date: May 29, 2025

(54) Coordinate Interleaved Power Index Modulation

(71) Applicants: Koc University, Sariyer (TR); VESTEL ELEKTRONIK SANAYI VE TICARET A.S., Manisa (TR)

(72) Inventors: Ali Tugberk Dogukan, Sariyer (TR); Ömer Furkan Tugtekin, Manisa (TR); Ertugrul Basar, Sariyer (TR); Basak Ozbakis, Manisa (TR)

(21) Appl. No.: 18/852,833

(22) PCT Filed: Mar. 31, 2022
(86) PCT No.: PCT/EP2022/058619

§ 371 Date: Sep. 30, 2024

(51) Int. Cl. H04L 27/26

(52) U.S. Cl. CPC H04L 27/2697

(57) ABSTRACT

Methods and techniques are described for increasing the reliability of data transmission at a high error performance in wireless transmission. In particular, a group of bits representing the data is split into symbol bits and carrier index bits and one or more component-interleaved symbols are generated. The one or more component-interleaved symbols correspond to complex symbols that are obtained by sequentially forming real and imaginary components of intermediate symbols out of said symbol bits; and interleaving said real and/or imaginary components among the intermediate symbols. A carrier index and a power value is determined for each of the one or more component-interleaved symbols based on the carrier index bits, and each of the one or more component-interleaved symbols is transmitted on a respective carrier given by the determined carrier index and with the determined power value.

### CROSS-REFERENCE TO RELATED APPLICATION

This application is the United States national phase of International Application No. PCT/EP2022/058619 filed Mar. 31, 2022, the disclosure of which is hereby incorporated by reference in its entirety.

### BACKGROUND OF THE INVENTION

### Field of the Invention

The present disclosure relates generally to communication, and, in some particular embodiments, to techniques for transmission of signals using coordinate interleaved OFDM.

### Description of Related Art

Wireless communication has been advancing over several decades now. Global communication systems as well as local network systems have been recently using technology based on Orthogonal Frequency Division Multiplexing (OFDM).

In OFDM, data symbols are simultaneously transmitted over a plurality of subcarriers. Data symbol here refers to a modulation symbol which may carry one or more data bits, depending on a modulation order. Simultaneously means within one OFDM symbol. An OFDM symbol is obtained by mapping the modulation symbols onto subcarriers of the transmission band and by then transforming the subcarriers by an inverse Fourier transformation (IFFT), or in general by an inverse orthogonal transformation. The OFDM symbol—now in time domain—is then provided for transmission. Before the transmission, still further operations may be used, such as operations in connection with multiple input multiple output (MIMO) processing or some further signal processing. The transmission may further include one or more of pulse shaping, amplification, and modulation onto the appropriate carrier frequency.

A total N log₂ M number of bits can be transmitted for each OFDM symbol, where N and M are the number of subcarriers in a resource unit (RU) and the modulation order, respectively.

Resource unit is a unit of allocable resources. For example, a minimum allocable resource unit may include a plurality of subcarriers in one or more OFDM symbols (corresponding to intervals in time domain). Here, the spectral efficiency of an OFDM system can be given as log₂ M. In IEEE (Institute of electrical and electronics engineers) 802.11 (Wi-Fi) standards, for example in IEEE 802.11ax (Wi-Fi 6), different modulation and coding schemes (MCSs) are defined with varying modulation order and coding rate. For example, MCSO is a scheme with binary phase shift keying (BPSK) (M=2) and ½ coding rate. In MCSO, only log₂ M=1 bit can be transmitted per subcarrier. Hence, this scheme may be used when the channel conditions are bad or the received signal strength is low. Dual carrier modulation (DCM), which modulates the same incoming bits over a pair of subcarriers with a same or different constellation, has been introduced to further improve the reliability. However, one of the major drawbacks of DCM is that it reduces the data rate by half. Other techniques have been introduced to make data transmission more reliable by diversity enhancement, including repetition coded OFDM (RC OFDM), OFDM with index modulation (OFDM-IM), or OFDM with power distribution index modulation (OFDM-PIM). In OFDM-IM, information bits are conveyed by the indices of activated subcarriers in addition to conventional M-ary signal constellations, as in classical OFDM. Coordinate interleaved OFDM-IM (CI-OFDM-IM) builds upon OFDM-IM which provides a diversity order of 2 by carrying the real and imaginary parts of the data symbols over different activated subcarriers. OFDM-PIM is an also OFDM-IM based scheme where subcarrier indices with high power are first determined, followed by assigning the remaining subcarrier indices to low power subcarriers. Finally, each data symbol is transmitted through two subcarriers with respective high and low power levels. However, these techniques have the drawback of insufficient spectral efficiency values and/or of a low diversity order. For example, in OFDM-IM and OFDM-PIM, the diversity order is 2.

Improving the diversity order is a challenging task.

### SUMMARY

Methods and techniques are described herein for facilitating a reliable data transmission and reception and enhanced diversity by using a coordinate interleaved modulation and power index modulation. For that purpose, the invention provides methods and techniques to provide higher diversity orders to improve the error performance and combat with fading channels more effectively.

For example, a method is provided for wireless transmission of data, the method comprising the steps of: dividing a group of bits representing the data into symbol bits and carrier index bits; generating one or more component-interleaved symbols that correspond to complex symbols that are obtained by (i) sequentially forming real and imaginary components of intermediate symbols out of said symbol bits; and (ii) interleaving said real and/or imaginary components among the intermediate symbols; determining a carrier index and a power value for each of the one or more component-interleaved symbols based on the carrier index bits; and transmitting each of the one or more component-interleaved symbols on a respective carrier given by the determined carrier index and with the determined power value.

Furthermore, a method is provided for wireless reception of data, the method comprising the steps of: receiving each of one or more component-interleaved symbols on a respective carrier given by a determined carrier index and with a determined power value, wherein the data is represented by a group of bits divided into symbol bits and carrier index bits; and the one or more component-interleaved symbols that correspond to complex symbols are obtained by: (i) sequentially forming real and imaginary components of intermediate symbols out of said symbol bits; and (ii) interleaving said real and/or imaginary components among the intermediate symbols; wherein the carrier index and the power value being determined for each of the one or more component-interleaved symbols based on the carrier index bits; and determining the data from the one or more component-interleaved symbols by a predefined detection method.

According to further embodiments, apparatuses are provided for transmission and reception if the signals which include processing circuitry configured to perform the steps of the respective transmitting and receiving methods mentioned above, as well as a transceiver configured to transmit or receive the signals.

The above mentioned circuitry may be any circuitry such as processing circuitry including one or more processors and/or other circuitry elements.

These and other features and characteristics of the presently disclosed subject matter, as well as the methods of operation and functions of the related elements of structures and the combination of parts and economies of manufacture, will become more apparent upon consideration of the following disclosure herein with reference to the accompanying drawings, all of which form a part of this specification. It is to be expressly understood, however, that the drawings are for the purpose of illustration and description only and are not intended as a definition of the limits of the disclosed subject matter. As used in the specification and the claims, the singular form of “a,” “an,” and “the” include plural referents unless the context clearly dictates otherwise.

### BRIEF DESCRIPTION OF THE DRAWINGS

The terms FIG., FIGS., FIGURE, and Figures are used interchangeably in the specification to refer to the corresponding figures in the drawings.

An understanding of the nature and advantages of various embodiments may be realized by reference to the following figures.

FIG. 1 is a block diagram illustrating an exemplary communication system.

FIG. 2a is a block diagram illustrating an exemplary transmitting device employing the coordinate interleaved power index modulation.

FIG. 2b is a block diagram illustrating an exemplary receiving device employing the coordinate interleaved power index modulation.

FIG. 3a is a block diagram illustrating an exemplary transmitting device employing the coordinate interleaved power index modulation.

FIG. 3b is a block diagram illustrating an exemplary receiving device employing the coordinate interleaved power index modulation.

FIG. 4 is a block diagram illustrating the generation of one subblock according to the coordinate interleaved power index modulation.

FIG. 5 is a benchmark plot BER versus SNR, comparing the coordinate interleaved power index modulation with other modulations.

FIG. 6a is a flow diagram illustrating exemplary steps performed by a transmitting device employing the coordinate interleaved power index modulation.

FIG. 6b is a flow diagram illustrating exemplary steps performed by a receiving device employing the coordinate interleaved power index modulation.

FIG. 7a is a block diagram showing an exemplary transmission chain employing OFDM and suitable for an exemplary implementation of some embodiments, including CI-PIM.

FIG. 7b is a block diagram showing an exemplary reception chain employing OFDM and suitable for an exemplary implementation of some embodiments, including CI-PIM.

Like reference numbers and symbols in the various figures indicate like elements, in accordance with certain example implementations.

### DESCRIPTION OF THE INVENTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the disclosed subject matter as it is oriented in the drawing figures. However, it is to be understood that the disclosed subject matter may assume various alternative variations and step sequences, except where expressly specified to the contrary. It is also to be understood that the specific devices and processes illustrated in the attached drawings, and described in the following specification, are simply exemplary embodiments or aspects of the disclosed subject matter. Hence, specific dimensions and other physical characteristics related to the embodiments or aspects disclosed herein are not to be considered as limiting unless otherwise indicated.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise.

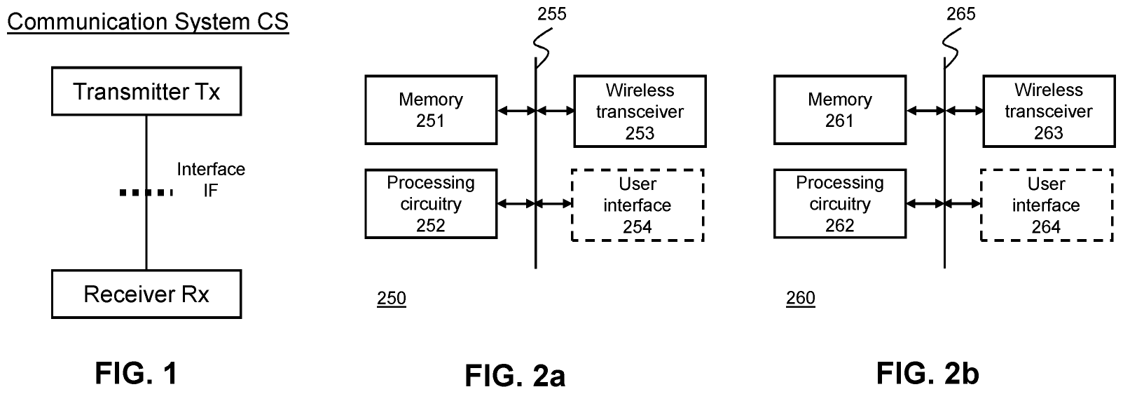

FIG. 1 illustrates an exemplary communication system CS in which Tx represents a transmitter and Rx represents a receiver. The transmitter Tx is capable of transmitting a signal to the receiver Rx over an interface IF. The interface may be, for instance, a wireless interface. The interface may be specified by means of resources, which can be used for the transmission and reception by the transmitter Tx and the receiver Rx. Such resources may be defined in one or more (or all) of the time domain, frequency domain, code domain, and space domain. It is noted that in general, the “transmitter” and “receiver” may be also both integrated in the same device. In other words, the devices Tx and Rx in FIG. 1 may respectively also include the functionality of the Rx and Tx.

The present disclosure is not limited to any particular transmitter Tx, receiver Rx and/or interface IF implementation. However, it may be applied readily to some existing communication systems as well as to the extensions of such systems, or to new communication systems. Exemplary existing communication systems may be, for instance the 5G New Radio (NR) in its current or future releases, and/or the IEEE 802.11 based systems such as the recently studied IEEE 802.11be or the like.

As mentioned in the background section, OFDM is a currently rather popular wideband multi-carrier transmission technology and has been used in many standards such as IEEE 802.11 (Wi-Fi), LTE (Long Term Evolution, which is a mobile communication system of 4th generation, 4G), New Radio (NR, which belongs to 5th generation, 5G). In OFDM, frequency band is divided into subbands and these bands are called subcarriers. The data symbols, which are obtained by mapping incoming bits with a constellation pertaining to a modulation scheme, are transmitted simultaneously over these subcarriers. A certain number of subcarriers forms a resource unit (RU). For example, an RU may include 26, 52, 106, 242, 484 or 996 subcarriers. In Wi-Fi standards such as IEEE 802.11ax (Wi-Fi 6), there are several MCSs which allow to adjust the data rate and communication range. For example, MCSO corresponds to BPSK with ½ coding rate and it provides the most reliable communication and the lowest data rate among all MCSs. It is noted that the present disclosure can readily be applied to OFDM systems, but is not limited thereto. It is conceivable that the present disclosure may be applied in general to other schemes such as frequency division multiplexing (FDM) or Generalized FDM (GFDM) or filtered OFDM or the like. The OFDM or the FDM is not limited to using FFT, but may use discrete Fourier transformation (DFT) or other transformations. At the receiver side, the time domain signal is received. Samples belonging to an OFDM symbol are transformed by a (forward) transformation such as fast Fourier transformation or the like. Thereby, modulation symbols mapped onto the subcarriers are obtained and de-mapped.

The term modulation here refers to mapping of one or more bits onto a signal point out of a plurality of signal points given by the modulation scheme. Arrangement of the signal points in the modulation scheme is sometimes also referred to as constellation. In case of BPSK, one bit of data is mapped onto one data symbol (modulation symbol). In the BPSK, the two possible signal points are typically antipodal, and represent two respective phases differing from each other by pi (180°).

Diversity generally helps to prevent a decrease in error performance caused by unreliable wireless fading channels, such as multipath fading. The idea behind using diversity techniques in data transmission is that it is highly unlikely that many statistically independent fading channels will undergo deep fading at the same time. There are several techniques that provide diversity in space, time, and frequency. For example, for frequency diversity, the transmission of the same data is repeated over adequately spaced frequency bands. Diversity determines the slope of the bit error rate (BER) versus signal-to-noise ratio (SNR). If the diversity order increases, BER decreases more rapidly with respect to SNR. Hence, a diversity enhancing scheme may need less transmission power for a target BER as compared to any other scheme that cannot provide a diversity gain.

Therefore, diversity enhancing schemes are highly demanded for various applications in existing and future wireless communication networks. As a result, diversity is a significant concept as it may enables improving the error performance and provides a more reliable and efficient data transmission over wireless channels.

OFDM is the most popular multicarrier waveform that has been used in several standards, such as long-term evolution (LTE) and IEEE 802.11 family. However, classical OFDM cannot provide a diversity gain. The inability of OFDM to ensure symbol detectability when deep fading occurs on those sub-channels is related to the fact that each symbol is conveyed over a single flat sub-channel that may experience fading. In the literature, various diversity enhancing techniques have been proposed to provide a diversity gain for OFDM systems. For example, in repetition coded OFDM (RC-OFDM), the same data symbol is transmitted over N different subcarriers to provide a diversity order of N. Nonetheless, since N subcarriers are used for the transmission of the same data symbol, it is difficult for RC-OFDM to provide high spectral efficiency values. Additionally, in an OFDM system, the maximum achievable diversity order is L, where L is the number of taps of wireless channel.

In the following, various techniques for diversity enhancement are briefly summarized.

The first technique refers to OFDM with index modulation (OFDM-IM) used in OFDM-based transmission, where information bits are transmitted via both a M-ary signal constellation as in conventional OFDM and the indices of active subcarriers. In OFDM-IM, while IM provides a diversity order of 2, data symbols modulated with M-ary signal constellation have a diversity order of 1. The minimum diversity order dominates the overall diversity order of the system. Therefore, the diversity order of an OFDM-IM scheme is 1. However, OFDM-IM provides a better error performance than classical OFDM, since information bits transmitted by the indices of active subcarriers are more preserved.

To improve the diversity order of OFDM-IM, coordinate interleaved OFDM-IM (CI-OFDM-IM) has been proposed, where the imaginary and real parts of the data symbols are transmitted over different subcarriers. In CI-OFDM-IM, a total number of m bits enter the system. Then, these m bits are divided into a number of G groups, each including a number of p bits, p=m/G. As in OFDM-IM, these p bits are split into two branches, with p=p₁+p₂ and p₁=└log₂(ₖⁿ)┘ and p₂=k log₂ M. The integer parameters n, k, and M are the subblock length, the number of active subcarriers in a subblock, and the modulation order, respectively. The p₁=└log₂(ₖⁿ)┘ bits determine the indices of the activated subcarriers (i_{g}=[i₁, i₂, . . . , iₖ]^{T}, iₐ∈{1, 2, . . . , n}, α=1, . . . , k) of the gth subblock, g=1, 2, . . . , G. The p2=k log₂ M bits determine k number data symbols x_{g}=[x1, x2, . . . , xₖ]^{T}, which are carried by the respective k activated subcarriers. After that, the data symbol vector x, is multiplied with a rotation angle θ, and the rotated data symbols s_{g} are obtained as: s_{g}=x_{g}e^{jθ}=[s₁, s₂, . . . , sₖ]^{T}, θ=[0,2π]. The CI technique is then applied to the rotated data symbols s_{g} as follows:

$${c}_{g} = {[ {c}_{1} , {c}_{2} , … , {c}_{k - 1} , {c}_{k} ]}^{T} = {[ {s}_{1}^{R} + {js}_{2}^{I} , {s}_{2}^{R} + {js}_{1}^{I} , … , {s}_{k - 1}^{R} + {js}_{k}^{I} , {s}_{k}^{R} + {js}_{k - 1}^{I} ]}^{T} ,$$

where sₐ^{R} and sₐ^{I} are the real and imaginary parts of αth data symbol sₐ, respectively. Finally, the kth element of c_{g} is placed into the gth subblock z_{g} by using the kth element of i_{g}, i.e. the kth index of the activated subcarriers. The same processes are performed for all of the G subblocks to obtain the overall OFDM symbol for all the subblocks g=1, 2, . . . , G. Here, since the real and imaginary parts of each data symbol are transmitted over different subcarriers, a diversity order of 2 can be provided, and hence improves the error performance of OFDM-IM. To illustrate the CI-OFDM-IM, assume that n=4, k=2, and i_{g}=[1,4]^{T}. With these parameters, an example subblock of CI-OFDM-IM scheme is obtained as:

$$z = {[ {s}_{1}^{R} + {js}_{2}^{I} , 0 , 0 , {s}_{2}^{R} + {js}_{1}^{I} ]}^{T} .$$

Another scheme that increases the diversity order of OFDM-IM up to 2 is OFDM with power distribution index modulation (OFDM-PIM). In OFDM-PIM, in contrast to OFDM-IM and CI-OFDM-IM, the number of active subcarriers k is always equal to n/2 that is the half of the subblock length. The partitioning of active subcarriers to two halves is motivated by the use of two different power levels, as explained below. As a result, p₁ and p₂ are given by

$${p}_{1} = ⌊ {log}_{2} ( \begin{matrix}n \\ n / 2\end{matrix} ) ⌋$$

and p₂=(n/2)log₂ M, respectively. For the gth subblock, a total number of

$${p}_{1} = ⌊ {log}_{2} ( \begin{matrix}n \\ n / 2\end{matrix} ) ⌋$$

bits determine the indices of the first n/2 of subcarriers with high power level (i_{g}^{H}=[i₁^{H}, i₂^{H}, . . . , i_{n/2}^{H}]^{T}), and the remaining second half n/2 of subcarriers are allocated as indices of subcarriers with low power level (i_{g}^{L}=[i₁^{L}, i₂^{L}, . . . , i_{n/2}^{L}]^{T}). Hence, the number of carriers are equally divided into two groups of high and low power carriers. A total number of p₂=(n/2)log₂ M bits determine n/2 data symbols x_{g}=[x₁, x₂, . . . , x_{n/2}]^{T}, which are carried by the first half of subcarriers. Then, x_{g} is multiplied with the square root of the high and low power levels (high: P^{H}, low: P^{L}, P^{H}>P^{L}) and data symbols with high and low powers are obtained as x_{g}^{H}=\sqrt{P^{H}}x_{g}=[x₁^{H}, x₂^{H}, . . . , x_{n/2}^{H}]^{T} and x_{g}^{L}=\sqrt{P^{L}}x_{g}=[x₁^{L}, x₂^{L}, . . . , x_{n/2}^{L}]^{T}, respectively. Finally, the kth element of x_{g}^{H} and x_{g}^{L} is placed into the gth subblock z_{g} by employing the kth element of the high and low power carrier indices i_{g}^{H} and i_{g}^{L}, respectively. The same processes are applied for all subblocks to obtain the overall OFDM symbol. For instance, assuming that n=4 and i^{H}=[1,3]^{T}, the remaining indices are ⁱL=[2,4]^{T}. Hence, with these parameters, an example subblock of the OFDM-PIM scheme is given by:

z=[x₁^{H},x₁^{L},x₂^{H},x₂^{L}]^{T}.

Here, as seen from the example subblock z, each data symbol (x₁ and x₂) is transmitted over two different subcarriers, but with different power levels. Therefore, a diversity order of 2 can be provided. Therefore, due to the different power levels, additional bits can be transmitted by IM. If P^{H} is selected to be equal to P^{L}, this scheme becomes repetition coded OFDM, where a data symbol is repeated over two different subcarriers. In repetition coded OFDM, information bits cannot be conveyed via the indices of subcarriers. In other words, IM cannot be applied. If P^{H}=P and P^{L}=0, in which case this scheme becomes the classical OFDM-IM.

The two above mentioned schemes CI-OFDM-IM and OFDM-PIM can provide only a diversity order of 2, so that their reliability may still be considered low for some applications.

For emerging wireless communication systems, a diversity order more than 2 is desirable, to provide a reliable data transmission and reception, emphasizing the significance of diversity techniques for wireless communication systems. However, diversity enhancement beyond 2 turns out to be a challenging task.

In order to enhance the diversity (i.e. the diversity order) of a transmitter and/or receiver, for example, of a communication system, the embodiments put forth herein utilize advantages of the techniques CI-OFDM-IM and OFDM-PIM. This is referred to in the following as coordinate interleaved power index modulation (CI-PIM). Moreover, a smart bits-to-subblock mapping approach is provided on the transmitter side, by which a desired diversity order is achievable, which is a desirable feature in emerging and future wireless communication networks.

In the following, apparatuses and methods are discussed, which provide functionalities of coordinate-interleaved power index modulation (CI-PIM), along with transmission and reception of the respective symbols.

FIG. 2a illustrates a transmitting device 250 according to some exemplary embodiments. The transmitting device 250 may be a part of any wireless communication device such as a station (STA) or access point (AP), or, in general base station (BS) or terminal (i.e. user equipment UE). The transmitting device 250 comprises memory 251, processing circuitry 252, and a wireless transceiver 253 (or a wireless transmitter 253), which may be capable of communicating with each other via a bus 255. The transmitting device 250 may further include a user interface 254. However, for some applications, the user interface 340 is not necessary (for instance some devices for machine-to-machine communications or the like).

The memory 251 may store a plurality of firmware or software modules, which implement some embodiments of the present disclosure. The memory may 251 be read from by the processing circuitry 252. Thereby, the processing circuitry may be configured to carry out the firmware/software implementing the embodiments. The processing circuitry 252 may include one or more processors, which, in operation, prepare a data for transmission.

In particular, the circuitry 252 is configured to divide a group of bits representing the data into symbol bits and carrier index bits. For example, the symbol bits may correspond to one or more bits of a modulation scheme, such as binary phase shift keying (BPSK), quadrature phase shift keying (QPSK), or in general an M-ary modulation such as quadrature amplitude modulation (QAM), or the like. In case of BPSK, the symbol bits are one bit representing a BPSK symbol. In case of QAM, the symbol bits are four bits representing a QAM symbol. For a given modulation scheme, the respective symbols (i.e. symbol bits) correspond to a constellation point within a constellation diagram in correspondence with the modulation scheme. Other modulations schemes include phase shift keying, PSK, pulse amplitude modulation, PAM, amplitude phase shift keying (ASK) or frequency shift keying (FSK). As such it is understood, that the above-listed target modulations also cover their respective subsets. PSK, for example, covers BPSK, DPSK, M-ary PSK, QPSK, OQPSK etc., FSK covers BFSK, M′ary FSK, MSK, GMSK etc., ASK covers on-off keying, M′ary ASK etc., QAM is commonly referred to as M-ary QAM covering rectangular QAM or circular QAM.

The processing circuitry 252 is further configured to generate one or more component-interleaved symbols that correspond to complex symbols that are obtained by (i) sequentially forming real and imaginary components of intermediate symbols out of said symbol bits and (ii) interleaving said real and/or imaginary components among the intermediate symbols. In an exemplary implementation, the component-interleaved symbols are obtained rotating the one or more intermediate symbols by applying a phase value. According to a preferred implementation, the phase value is different for each of the one or more intermediate symbols. The use of a different phase value provides a diversity order of the number of intermediate symbols subject to rotation. Alternatively, the phase value may be same for each of the intermediate symbols. Interleaving means combining (i.e. mixing) real and imaginary components of different intermediate symbols. For example, two intermediate symbols x₁^{R}+ix₁^{I} and x2+ix₂^{I} may be combined by merging the imaginary part (i.e. component) of the second intermediate symbol with the real part of the first intermediate symbol, while merging the imaginary part of the first intermediate symbol with the real part of the second intermediate symbol. Instead of forming intermediate symbols and interleaving their components, the component-interleaved symbols may be obtained by direct mapping of bits onto component-interleaved symbols without physically performing the intermediate step(s). The processing circuitry 252 is further configured to determine a carrier index and a power value for each of the one or more component-interleaved symbols based on the carrier index bits. This means that each of the one or more component interleaved symbols are assigned to those carriers having the determined carrier index and respective power value. In other words, each component interleaved symbol may be mapped onto a respective subcarrier. The term subcarrier may simply referred to as carrier.

The wireless transceiver 253 is configured to transmit each of the one or more component-interleaved symbols on a respective carrier given by the determined carrier index and with the determined power value. In other words, each component-interleaved symbol is transmitted with a power according to the power value. The wireless transceiver 253 may perform further operations. Such further operations may include an inverse transformation such as the inverse fast Fourier transform (IFFT) or an inverse discrete cosine transform (IDCT), in accordance with the desired (orthogonal or non-orthogonal) frequency division multiplex. Moreover, the transformed time-domain symbols may then be modulated onto the actual carrier, amplified or the like, before transmitting the component-interleaved symbols via an RF front-end.

As FIG. 2a shows, the memory 251 may be separated from the processing circuitry 252. However, this is only an example. In general, the memory 251 may be implemented within the processing circuitry 252, and e.g., within the one or more processors. The term “memory” refers to any type of long term, short term, volatile, nonvolatile, or other memory and is not to be limited to any particular type of memory or number of memories, or type of media upon which memory is stored.

The wireless transceiver 253 may operate according some known resource multiplexing and/or multi-user multiplexing scheme. In general, any currently used scheme such as those employed in the IEEE 802.11 framework or in the 5G/6G framework are applicable. In particular, possible examples include the OFDM, OFDMA, or non-orthogonal multiple access (NOMA) or the like.

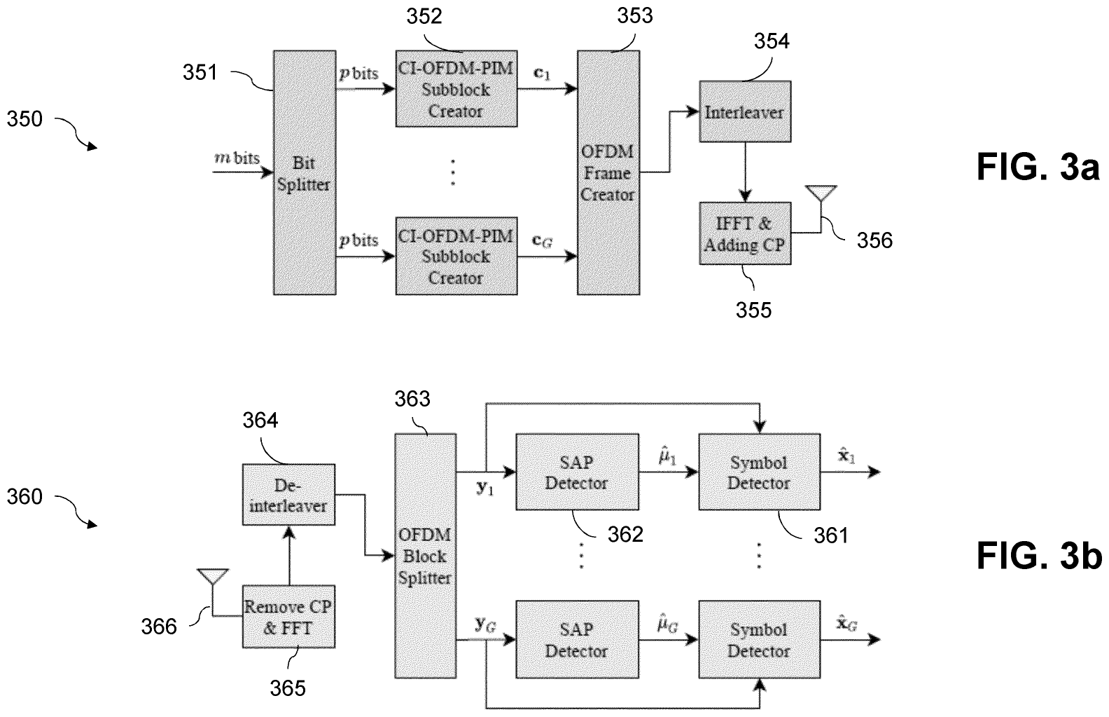

FIG. 3a shows an exemplary implementation of a transmitter 350, performing the CI-PIM, as detailed in the following. In this implementation example of the transmitter 350, OFDM waveforms are utilized to generate an OFDM subblock. It is noted that the CI-PIM is not limited to OFDM waveforms and may include also non-orthogonal waveforms. The transmitter 350 may be part of a transceiver-receiver system, where the transmitter 350 transmits the component-interleaved symbols to a receiver 360 shown in FIG. 3b. The receiver 360 will be detailed further below. The transmitter 350 shown in FIG. 3a includes a bit splitter 351, one or more CI-OFDM-PIM subblock creators 352, an OFDM frame creator, interleaver 354, IFFT and adding CP 355, and an RF front end 356. The RF front end 356 may include a single antenna or multiple antennas. Thereby, the acronym CI-OFDM-PIM means coordinate-interleaved OFDM with power index modulation, which includes the index modulation. Hence, CI-OFDM-PIM refers to the CI-PIM utilizing OFDM waveforms.

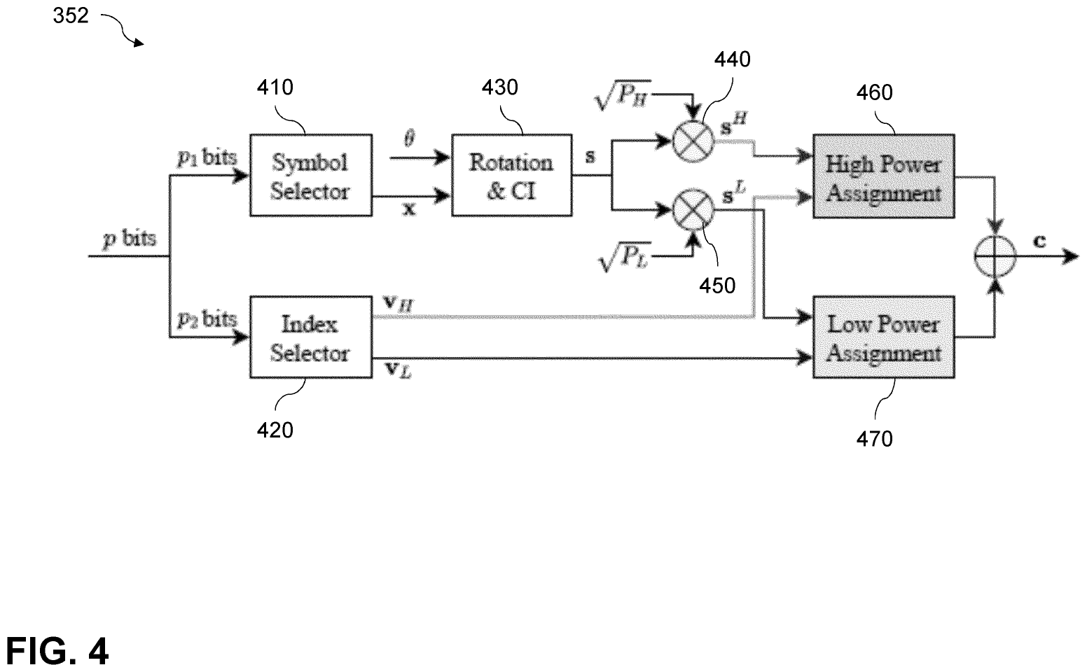

In the following it is assumed that, within the CI-PIM approach, S number of subcarriers are used to transmit a total number of m bits via component-interleaved symbols. As FIG. 3a shows, the m bits are provided as input to the transmitter 350, where the bit splitter 351 splits the m bits into a number of G groups, where each group includes an integer number of p=m/G bits. A group may be also referred to as a subblock and has a length N=S/G, where N is an even number and greater than 2. Hence, with the transmission of a subblock (group) using the N subcarriers for each group g=[1, . . . , G], a total number of m bits can be transmitted. For that purpose, a group is generated by the processing performed by the CI-OFDM-PIM subblock creator 352 shown in FIG. 4. The CI-OFDM-PIM subblock creator includes functional units of symbol selector 410, index selector 420, rotation and CI 430, a first multiplicator 440, a second multiplicator 450, high power assignment 460, and low power assignment 470. Since the processing applies for each group, the processing is detailed for creating the gth subblock c., while dropping the subscript g merely labeling the index of the group to simplify the notation. It is noted that this does not introduce any ambiguity.

FIG. 4 shows the block diagram for the generation of the gth subblock. After the splitting of the m bits into a group of an integer number of p bits, the p bits are input to the CI-OFDM-PIM subblock creator. According to an embodiment, the processing circuitry 252 is configured to split the p bits into p=p₁+p₂ bits, wherein p₁ is the number of the symbol bits given by

$${p}_{1} = ( \frac{N}{2} ) {log}_{2} ( M )$$

and p₂ is the number of the carrier index bits given by p₂=log₂(N). N refers to a length of a data block corresponding to the data, N being an even integer larger than two and M being the modulation order. N and M are given by 2 power to an integer larger than 0. Hence, the p₁=(N/2)log₂(M) bits determine the N/2 complex data symbols x=[x₁, . . . , x_{N/2}]^{T}∈ [symbol] ^{N/2}, where [⋅]^{T} is the transposition operation. The complex symbols x=[x₁, . . . , x_{N/2}]^{T} may be also referred to as complex symbol vector or simply as symbol vector. For given p₁ data bits, the symbol selector 410 selects the symbols. For example, the N/2 complex symbols may be drawn from an M-QAM signal constellation according to the modulation order M. Which of the carriers among the N subcarriers are active for transmission is determined by the p2 bits defining a subcarrier activation pattern (SAP) v=[v₁, v₂, . . . , v_{N}]^{T}, with v_{χ}∈{1, . . . , N} and χ=1, 2, . . . , N. With reference to FIG. 4, the p₁ and p₂ bits are input to symbol selector 410 and index selector 420, respectively. The index selector 420 determines for each of the one or more component-interleaved symbols the carrier index based on the carrier index bits, i.e. the bits p₂.

To ensure a diversity gain, constellation rotation is a significant component of a coordinate interleaving based transmission scheme. In an implementation, the complex data symbols x=[x₁, . . . , x_{N/2}]T, i.e. each symbol xᵢ with i=1, . . . , N/2 may be rotated by applying a phase value, with said symbols x=[x₁, . . . , x_{N/2}]^{T} referring to the one or more intermediate symbols. In a preferred implementation, the phase value is different for each of the one or more intermediate symbols. In the example of FIG. 4, said rotation is performed by the unit rotation and CI 430. For example, the n-th element of the complex symbol vector x is rotated with an angle θₙ, n=1, 2, . . . , N/2, and the rotated data symbol vector is obtained as:

$${x}^{θ} = {[ {x}_{1} {e}^{j {θ}_{1}} , {x}_{2} {e}^{j {θ}_{2}} , … , {x}_{N / 2} {e}^{j {θ}_{N / 2}} ]}^{T} = {[ {\overline{x}}_{1} , {\overline{x}}_{2} , … , {\overline{x}}_{N / 2} ]}^{T} . \qquad ( 1 )$$

with j=\sqrt{−1} denoting the positive imaginary unit. In the above example of using N/2 different phase values, a diversity order of N/2 is provided. This symbol rotation is performed by the rotation and CI 430 shown in FIG. 4.

As such, the rotated data symbol vector comprising N/2 rotated complex symbols may be interpreted as being generated by sequentially forming real and imaginary components of intermediate symbols out of said data symbols bits p₁. It is noted that the component-wise symbol rotation may be combined with other kind of operations to obtain data symbol vector x^{θ} to ensure a diversity gain.

After symbol rotation, coordinate interleaving (CI) is applied to the rotated data symbol vector x^{θ} and a coordinate interleaved data symbol vector s is obtained as:

$$s = [ \begin{matrix}{s}_{1} \\ {s}_{2} \\ ⋮ \\ {s}_{N / 2 - 1} \\ {s}_{N / 2}\end{matrix} ] = [ \begin{matrix}{\overline{x}}_{1}^{R} + j {\overline{x}}_{2}^{I} \\ {\overline{x}}_{2}^{R} + j {\overline{x}}_{1}^{I} \\ ⋮ \\ {\overline{x}}_{N / 2 - 1}^{R} + j {\overline{x}}_{N / 2}^{I} \\ {\overline{x}}_{N / 2}^{R} + j {\overline{x}}_{N / 2 - 1}^{I}\end{matrix} ] . \qquad ( 2 )$$

Thereby, x̅ᵢ^{R} and x̅ᵢ^{I} refer to the real and imaginary component (i.e. the real and imaginary part) of α-th complex symbol x̅_{α} with i=1, . . . N/2. In the example of FIG. 4, the CI is also performed by the unit rotation and CI 430. As may be discerned from equation (2), the component interleaving is performed between the (2α−1)th and (2α)th elements of the rotated data symbols x8. The component interleaving may be performed on other ways, for example, by interleaving the real and imaginary parts of the first and third data symbols, and of the second and fourth symbol. This means that the first to fourth symbols form a symbol group of four elements. This would then be repeated for the neighboring symbol group, including the fifth to eight symbols, etc. Since the interleaving commonly relies on pairwise interleaving, the respective symbol group should preferably have an even number of symbols. Similar advantages may be achieved by a relative shift between the real and imaginary part, so that in some conceivable embodiments, the imaginary part is not shifted, but the real part is shifted. Both parts may be shifted, as long as the shift is different for the real and imaginary part.

In an exemplary implementation, the symbol rotation and the coordinate interleaving is performed by processing circuitry 252 of transmitting device 250 of FIG. 2a. In other words, a single unit of the rotation and CI unit 430 of FIG. 4 is included in circuitry 252. Alternatively, the symbol rotation and CI may be performed by separate functional units, in which a rotation unit first performs the rotation of the data symbols after the selection of symbols by symbol selector 410. The CI unit then follows after the rotation unit, so as to perform the coordinate interleaving of the rotated symbols. Still, as a preferred implementation, the separate function units of rotation and CI may still be included processing circuitry 252.

In order to obtain the component-interleaved symbols to be transmitted, the rotated symbol vector s is multiplied with a power level. According to an embodiment, each of the one or more component-interleaved symbols is transmitted at least with two different power values. The two different power levels are among a predefined set of power values including a first power value and a second power value being lower than the first power value. Moreover, the determined power value is a value among the predefined set of power values. Here, two power levels are specified as P_{H} (high) and P_{L} (low) for the subcarriers with high and low power, respectively. Further, P_{H}>P_{L} and P_{H}+P_{L}=2, since the average power of a subcarrier is normalized to unity, i.e., E{c^{H}c}=N, where E{⋅} and (⋅) H represents expectation and Hermitian transposition, respectively. Hence, P_{H} refers to the first power level and P_{L} refers to the second power level. The data symbol vector s is then multiplied with P_{H} and P_{L}, by which high and low power data symbol vectors are obtained as s^{H}=\sqrt{P_{H}}s and s^{L}=\sqrt{P_{L}}s, respectively. The multiplication with P_{H} and P_{L} are performed by multiplicators 440 and 450 in FIG. 4. With the above described processing, symbols s^{H} and s^{L} are generated as component-interleaved symbols, which are transmitted on a respective carrier. In the above example, the predefined set of power levels may comprise the two power levels P_{H} and P_{L}. Alternatively, the predefined set of power levels may include more than the two power levels P_{H} and P_{L}. Therefore, when more than two power levels are used, more than the two symbols s^{H} and s^{L} may be generated from the coordinate interleaved data symbol vector s by multiplying s with the more than two power levels from the predefined set. With respect to FIG. 4, this implies that after the unit rotation and CI 430, there would be further multiplicators according to the number of power levels used. Alternatively, CI-OFDM-PIM subblock creator 352 may include a number of units of multiplicators according to the number of different power levels included in the predefined set. In this case, for example, the CI-OFDM-PIM subblock creator 352 may further perform a function of selecting among the predefined set two or more power levels. The selection may be based on optimizing the minimum coding gain distance while minimizing power. Depending on the selected power values which may be, for example, grouped according to their value in increasing order, the unit rotation and CI 430 may then signal to each of the multiplicators whether it is used or not (active or inactive). Such signaling may be performed by a respective bit, with “1” being active and “0” being inactive for each multiplicator.

Before the component-interleaved symbols are transmitted, the respective gth subblock is to be generated using the high and low power symbols s^{H} and s^{L}, along with assigning them respective subcarriers in accordance with the carrier index bits p₂ for the respective power values. In other words, the determined carrier index is associated with one power value of the predefined set. To do that, the above-mentioned subcarrier activation pattern v=[v₁, v₂, . . . , v_{N}]^{T} is to be linked with the power values. In an preferred implementation, the carrier index bits encode the carrier indices sequentially according to decreasing values of the power values of the predefined set. For example, the first half and second half of v represent the indices of subcarriers with high power and low power as v_{H}=[v₁, . . . , v_{N/2}]^{T} and v_{L}=[n_{N/2+1}, . . . , v_{N}]^{T}, respectively. v_{H} and v_{L} may be referred to as carrier index group (e.g. a first carrier index group and a second carrier index group). With respect to the option of using more than two different power values, the N indices would then be divided into a number of carrier index groups in accordance with the number of selected power values. The high and low power symbols s^{H} and s^{L} can now be placed into the gth subblock c with the entries of v_{H} and v_{L}, respectively. This is performed by the units high power assignment 460 and low power assignment 470 in FIG. 4, each using their respective high and low power carrier indices and high and low power symbols as input, respectively.

The principle behind the assignment of carrier indices with respect to power values and the respective symbol bits is based on the following. The minimum distance of a set Z of codewords with length N_{c} is defined as d=min_{z}_{₁}_{,z}_{₂}_{∈Z,z}_{₁}_{≠z}_{₂}d(z₁,z₂), where d(z₁,z₂) represents the Hamming distance between z₁ and z₂. In a Q-ary block code of length N_{c} and minimum distance d, the number A_{Q}(N_{c},d) indicates the maximum number of possible codewords. Here, Singleton bound states that A_{Q}(N_{c},d)≤Q^{N}^{_{c}}^{-d+1}, as known from the literature. In the approach of the present disclosure, all possible SAPs can be considered as codewords in a N-ary block code of length N. To provide a diversity order of N, d should be selected as N. Hence, a total Q^{N}^{_{c}}^{-d+1}=N^{N-N+1}=N number of SAPs can be utilized for the transmission of index bits according to the Singleton bound. There are a total number of 2^{p}^{₂}=N possible SAPs. The first SAP is given as (v)₁=[1, 2, . . . , N]^{T} and μth SAP (v)_{μ} can be obtained by circularly shifting (v)₁ with μ−1 elements.

This may be illustrated as follows. Assume that the subblock length is N=4, incoming bits p₁=[0 0], a symbol vector s=[s₁ s₂]^{T}, and all possible SAPs can be obtained as in Table 1.

TABLE 1
The subcarrier indices according to incoming p₁ bits for N = 4.

| p₁ bits | v_{H}^{T} | v_{L}^{T} | c^{T} |
|---|---|---|---|
| [00] | [1, 2] | [3, 4] | [s₁^{H} s₂^{H} s₁^{L} s₂^{L}] |
| [01] | [4, 1] | [2, 3] | [s₂^{H} s₁^{L} s₂^{L} s₁^{H}] |
| [10] | [3, 4] | [1, 2] | [s₁^{L} s₂^{L} s₁^{H} s₂^{H}] |
| [11] | [2, 3] | [4, 1] | [s₂^{L} s₁^{H} s₂^{H} s₁^{L}] |

The first SAP is given by (v)₁=[1,2,3,4]^{T}, which is split into a first half of high power carrier indices v_{H}=[1,2]^{T} and lower power carrier indices v_{L}=[3,4]^{T}. Likewise, the remaining SAPs are created by a cyclic shift of (v)₁. For example, the second SAP (v)₂ is created by a cyclic shift of the carrier indices (v)₁=[1,2,3,4]^{T} by one elements, providing (v)₂=[4,1,2,3]^{T} and subsequently split into v_{H}=[4,1]^{T} and v_{L}=[2,3]^{T}. In the same way, the third and fourth SAP are created by a cyclic shift of (v)₁=[1,2,3,4]^{T} by two and three elements, respectively, providing (v)₃=[3,4,1,2]^{T} and (v)₄=[2,3,4,1]. The third and fourth SAP are then split into two groups of high and low power carrier indices, listed in Table 1. In the above example, there are N=4 possible v=[v_{H}^{T}v_{L}^{T}]^{T} vectors and the Hamming distance between each v pair is N=4. According to the incoming p₁=[0 0] bits, v_{H}=[1,2]^{T} and v_{L}=[3,4]^{T}. With those high and low power carrier indices v_{H}=[1,2]^{T} and v₁=[3,4]^{T}, the symbol components s₁ and s₂ are mapped such that s₁ is carried by carrier index 1, and s₂ is carried by carrier index 2, both carrier indices being high power. Likewise, for the low carrier index 3 and 4, s₁ is carried by carrier index 3, and s₂ is carried by carrier index 4. With respect to the order to the carrier indices 1, . . . , 4, in this example, the example subblock is created as:

$$c = {[ {s}_{1}^{H} , {s}_{2}^{H} , {s}_{1}^{L} , {s}_{2}^{L} ]}^{T} , \qquad ( 3 )$$

where sₐ^{H}=\sqrt{P_{H}}sₐ and sₐ^{L}=\sqrt{P_{L}}sₐ represent the coordinate interleaved data symbols with high and low power, respectively, and a=1,2. The symbol block c is provided as output of the CI-OFDM-PIM subblock creator 352 of FIG. 3a and FIG. 4.

Using the second SAP (v)₂=[4,1,2,3]^{T} with v_{H}=[4,1]^{T} and v₁=[2,3]^{T}, the symbols s₁ and s₂ are mapped such that s₁ is carried by carrier index 4, and s₂ is carried by carrier index 1 for the high power carriers, while for the low power carriers, s₁ is carried by carrier index 2, and s₂ is carried by carrier index 3. Again, with respect to the order of the carrier indices 1, . . . 4, the components s₁ and s₂ are arranged such that the second subblock reads c=[s₂^{H}s₁^{L}s₂^{L}s₁^{H}]^{T}. By following the same steps for all subblocks g=[1, . . . , G], the whole OFDM frame is generated by OFDM frame creator 353 in FIG. 3a. In this manner, the carrier indices (and hence the carrier index bits) determine the high and low power carrier indices, but also how the symbols components are mapped onto the carrier indices dependent in the incoming data symbol bits.

Then, the G subblocks are further interleaved by applying interleaver 354, which may be a block-type interleaver. The use of a block-type interleaver enables the reduction of channel correlations. After taking inverse fast Fourier transform (IFFT) and inserting a cyclic prefix (CP) with length S_{CP} by unit IFFT and adding CP 355, the time-domain signal is obtained and transmitted over T-tap frequency selective Rayleigh fading channel, whose elements follow [symbol] (0,1/T) distribution. The time domain signals, and hence the component-interleaved signals may be transmitted wirelessly over a single antenna 356 shown in FIG. 3a or multiple antennas

The above described processing of transmitter 350 of FIG. 3a may be performed by transmitter Tx of FIG. 1 or transmitting device 250 of FIG. 2a. via processing circuitry 252. The wireless transceiver 253 may include a single antenna such as the antenna 356 in FIG. 3a or multiple antennas.

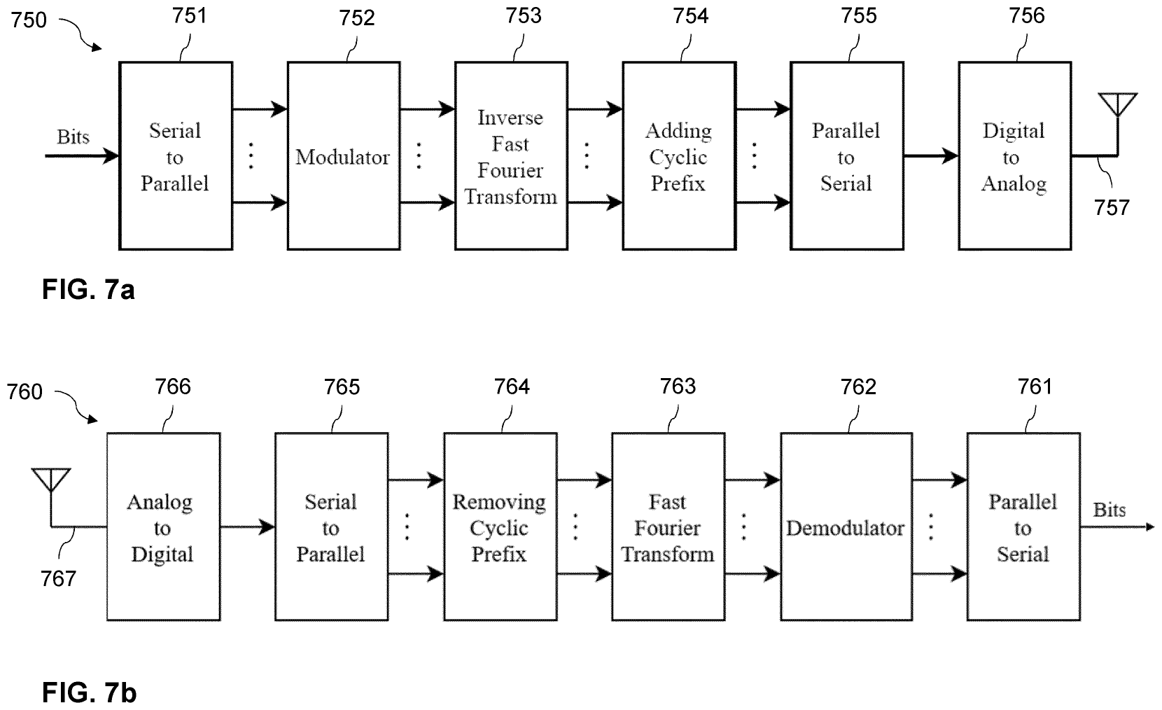

An exemplary transmitter 750 is illustrated in FIG. 7a for OFDM, representing structural units (i.e. functional units) which may be included in the general transmitter Tx in FIG. 1 or in the transmitting device 250 of FIG. 2a. Accordingly, data of bits is obtained for the transmission, with said bits in FIG. 7a being the m bits of transmitter 350 of FIG. 3a. The bits may be obtained, for example, from a preceding processing such as forward error coding, rate matching, insertion of a CRC and/or multiplexing data for different users or the like. They are then parallelized in the serial to parallel module 751 in order to match the size of the inverse transformation to be taken. Modulator 752 modulates the bits in modulation symbols with a modulation such as BPSK or QPSK, nQAM, or the like and perform, as will be described in the following, mapping of the modulation symbols onto the subcarriers to be transformed into one OFDM symbol. Such mapping may correspond to the mapping according to any of the embodiments described in the following. In particular, modulator 752 of FIG. 7a may perform parts of the functions of transmitter 350, including functional blocks to perform CI-PIM modulation, such as the bit splitter 351, the one or more CI-OFDM-PIM subblock creators 352, the OFDM frame creator, and the interleaver 354. It is noted that, for example the interleaver 354 may be a functional block on its own in the transmitter 750 of FIG. 7a, and may be placed after modulator 752. In other words, parts of the functional units of transmitter 350 in FIG. 3a may be easily embedded into common OFDM transmitter architecture, such as the one shown in FIG. 7a. As noted before, the transmitter 750 is an example of an OFDM transmitter performing modulation using the CI-PIM of the present disclosure.

After the modulation 752, an inverse transformation (here, exemplarily, the inverse fast Fourier transformation, IFFT) 753 is applied to obtain an OFDM symbol. The OFDM symbol may be added a cyclic prefix (CP) in the CP module 754. It is noted that the IFFT and CP addition may be performed by separate function units, as shown in FIG. 7a. Alternatively, the IFFT and CP addition may be performed by a single unit, as exemplarily illustrated by IFFT and adding CP unit 355 in FIG. 3a. After parallel to serial conversion 755, the signal is passed to the front end for the transmission. This may include digital to analog conversion 756 and further amplification or signal shaping steps. It is noted that the transceiver modules 753 to 756 are only exemplary and the present disclosure is not limited thereto. There may be further modules or the present modules may have further functionalities, such as peak-to-average power ratio (PAPR) reduction or the like. As mentioned above, OFDM is also only an exemplary wireless transmission kind. In general, alternative approached such as NOMA or the like are possible.

In some embodiments, the processing circuitry performing the functions described herein may be integrated within an integrated circuit on a single chip. The output of the processing circuitry is the combined signal in time domain. It may be a discrete signal, which the processing circuitry may provide to a transceiver 253 of transmitting device in FIG. 2a for transmission. The processing circuitry may also implement a control function to control the transceiver 253 to transmit the signal. The transceiver 253 is configured (e.g. by the processing circuitry 252) to transmit a signal by means of symbols carrying the generated signal. For example, the processing circuitry 252 may configure (control) the transceiver 253, over the bus 255, to transmit the signal. The transceiver may be, for example a wireless transceiver.

With the above mentioned transmitting device performing CI-PIM modulation of incoming bits as described, the diversity order of N beyond 2 can be provided. Accordingly, due to the enhanced diversity gain, the transmission of data becomes more reliable.

So far, an apparatus for wireless transmission of data performing CI-PIM modulation has been described above, which transmits the respective component-interleaved symbols on a respective carrier given by the determined carrier index bits and with the determined power value. Said apparatus may be the general transmitter Tx in FIG. 1, transmitting device 250 of FIG. 2a, transmitter 350 of FIG. 3a, and transmitter 750 in FIG. 7a. In the following, the receiver side will be detailed with reference to the reception of data modulated by CI-PIM.

FIG. 2b illustrates a receiving device 260 according to some exemplary embodiments. The receiving device 260 comprises memory 261, processing circuitry 262, and a wireless transceiver 263 (or a wireless receiver 263), which may be capable of communicating with each other via a bus 265. The receiving device 260 may further include a user interface 264. However, for some applications, the user interface 264 is not necessary (for instance some devices for machine-to-machine communications or the like).

The memory 261 may store a plurality of firmware or software modules, which implement some embodiments of the present disclosure. The memory may 261 be read from by the processing circuitry 262. Thereby, the processing circuitry may be configured to carry out the firmware/software implementing the embodiments. The processing circuitry 262 may include one or more processors, which, in operation, determines data.

In some embodiments, the processing circuitry 262 performing the functions described herein may be integrated within an integrated circuit on a single chip. The processing circuitry may also implement a control function to control the transceiver 263 to receive the signal. The transceiver 263 is configured (e.g. by the processing circuitry 262) to receive a signal and obtain symbols carried therein. For example, the processing circuitry 262 may configure (control) the transceiver 263, over the bus 265, to receive the signal. The transceiver may be, for example a wireless transceiver obeying some standard or some pre-defined rules in order to comply with the transmitter, e.g. the one described with reference to FIG. 2a.

The transceiver/receiver 263 is configured to receive each of one or more component-interleaved symbols on a respective carrier given by a determined carrier index and with a determined power value. The processing circuitry 262 may include one or more processors, which, is/are configured to determine the data from the one or more component-interleaved symbols.

Moreover, and correspondingly to the above described transmitter, the data is represented by a group of bits divided into symbol bits and carrier index bits. Further, the one or more component-interleaved symbols that correspond to complex symbols are obtained by (i) sequentially forming real and imaginary components of intermediate symbols out of said symbol bits; and (ii) interleaving said real and/or imaginary components among the intermediate symbols. Thereby, the carrier index and the power value are determined for each of the one or more component-interleaved symbols based on the carrier index bits.

In general, at the receiver, before the above mentioned processing, the signal (i.e. the one or more component-interleaved symbols) may be received over one or more antennas of the receiver, amplified, and transformed into frequency domain by a transformation, such as FFT or DFT (Discrete Fourier Transformation), corresponding to the inverse transformation which has been applied at the encoder. After removing CP, FFT and deinterleaver are applied to obtain the frequency domain signal. The equivalent input-output equation for the gth subblock, generated by CI-OFDM-PIM subblock creator 352 of the transmitter 350 of FIG. 2a, as described above, can be indicated in the frequency-domain as follows:

$${y}_{g} = {C}_{g} {h}_{g} + {w}_{g} , \qquad ( 4 )$$

where y_{g}, h_{g}=[h_{g,1}, . . . , h_{g,N}]^{T}, and w_{g}=[w_{g,1}, . . . , w_{g,N}]^{T} are the received signal vector, channel coefficients, and noise vector for the corresponding gth subblock, respectively, where the channel coefficient h_{∈}˜ [symbol] (0,1) (i.e. its has zero mean and unit variance), w_{∈}˜ [symbol] (0,N₀) (i.e. zero mean and variance N₀), ∈=1, . . . , N, and C_{g}=diag(c_{g}), diag(⋅) is the diagonalization.

Here, the signal-to-noise (SNR) ratio is defined as Γ=E_{b}/N₀, where E_{b}=(S+S_{CP})/m is the average bit energy. The data are determined from the one or more component-interleaved symbols by a pedefined detection method. According to an implementation, the predefined method is maximum likelihood, ML, detection on the one or more component-interleaved symbols.

In order to detect the gth subblock, the maximum-likelihood (ML) rule can be applied by employing the set {c₁, c₂, . . . , c₂_{^{p}}}∈ [symbol] which consists of all possible subblock realizations:

$${\hat{c}}_{g} = arg {min}_{{c}_{g} ∈ 𝒞} {‖ {y}_{g} - {C}_{g} {h}_{g} ‖}^{2} . \qquad ( 5 )$$

Recall that p=p₁+p₂ refers to the number of bits for one group, with p₁ and p₂ being thbits to encode the N/2 data symbols and the subcarrier activation pattern SAP entailing N components. Hence, in this case, the ML detection is applied on all symbols within a group. The number of metrics calculated in equation (5) is NM^{N/2} and therefore, the ML detector becomes significantly complicated for high values of N and M.

In a preferred implementation, the predefined detection method is independently applied on each of the one or more component-interleaved symbols, so as to individually detect the one or more component-interleaved symbols. For example, the number of metrics calculated for the symbol detection can be reduced by exploiting the single-symbol ML decoding property of coordinate interleaved orthogonal designs (CIODs). For the gth subblock, equation (4) may be rewritten without loss of generality as follows:

$$[ \begin{matrix}{y}_{1} \\ ⋮ \\ {y}_{N}\end{matrix} ] = [ \begin{matrix}{c}_{1} & & \\ & ⋱ & \\ & & {c}_{N}\end{matrix} ] + [ \begin{matrix}{w}_{1} \\ ⋮ \\ {w}_{N}\end{matrix} ] .$$

For each realization of the high and low power carrier indices (v)_{μ}=([v_{H}^{T}v_{L}^{T}]T)_{μ} determined as described above (see also Table 1 as example), with μ=1, . . . , N, N equivalent channel models can be obtained for each pair of (x_{α}, x_{β}) by the ML detector, which read as follows:

$${[ \begin{matrix}{y}_{{v}_{2 α - 1}}^{R} \\ {y}_{{v}_{2 α - 1}}^{I} \\ {y}_{{v}_{2 α}}^{R} \\ {y}_{{v}_{2 α}}^{I} \\ {y}_{{v}_{2 β - 1}}^{R} \\ {y}_{{v}_{2 β - 1}}^{I} \\ {y}_{{v}_{2 β}}^{R} \\ {y}_{{v}_{2 β}}^{I}\end{matrix} ]}_{μ} = {[ \begin{matrix}{h}_{{v}_{2 α - 1}}^{R} & 0 & 0 & 0 & 0 & - {h}_{{v}_{2 α - 1}}^{I} & 0 & 0 \\ {h}_{{v}_{2 α - 1}}^{I} & 0 & 0 & 0 & 0 & {h}_{{v}_{2 α - 1}}^{R} & 0 & 0 \\ 0 & - {h}_{{v}_{2 α}}^{I} & 0 & 0 & {h}_{{v}_{2 α}}^{R} & 0 & 0 & 0 \\ 0 & {h}_{{v}_{2 α}}^{R} & 0 & 0 & {h}_{{v}_{2 α}}^{I} & 0 & 0 & 0 \\ 0 & 0 & {h}_{{v}_{2 β - 1}}^{R} & 0 & 0 & 0 & 0 & - {h}_{{v}_{2 β - 1}}^{I} \\ 0 & 0 & {h}_{{v}_{2 β - 1}}^{I} & 0 & 0 & 0 & 0 & {h}_{{v}_{2 β - 1}}^{R} \\ 0 & 0 & 0 & - {h}_{{v}_{2 β}}^{I} & 0 & 0 & {h}_{{v}_{2 β}}^{R} & 0 \\ 0 & 0 & 0 & {h}_{{v}_{2 β}}^{R} & 0 & 0 & {h}_{{v}_{2 β}}^{I} & 0\end{matrix} ]}_{μ} [ \begin{matrix}{x}_{α}^{( H , R )} \\ {x}_{α}^{( H , I )} \\ {x}_{α}^{( L , R )} \\ {x}_{α}^{( L , I )} \\ {x}_{β}^{( H , R )} \\ {x}_{β}^{( H , I )} \\ {x}_{β}^{( L , R )} \\ {x}_{β}^{( L , I )}\end{matrix} ] + {[ \begin{matrix}{w}_{{v}_{2 α - 1}}^{R} \\ {w}_{{v}_{2 α - 1}}^{I} \\ {w}_{{v}_{2 α}}^{R} \\ {w}_{{v}_{2 α}}^{I} \\ {w}_{{v}_{2 β - 1}}^{R} \\ {w}_{{v}_{2 β - 1}}^{I} \\ {w}_{{v}_{2 β}}^{R} \\ {w}_{{v}_{2 β}}^{I}\end{matrix} ]}_{μ} \qquad ( 7 )$$

where x_{γ}=[x_{γ}^{H}x_{γ}^{L}]^{T} refers to a pair of symbols mapped onto high and low carrier indices, γ∈{α,β}.

Equation (7) can be rewritten in the following manner:

$${( {\tilde{y}}_{ξ} )}_{μ} = {( {\tilde{H}}_{ξ} )}_{μ} {\tilde{x}}_{ξ} + {( {\tilde{w}}_{ξ} )}_{μ} = [ {( {\tilde{H}}_{ξ , 1} )}_{μ} {( {\tilde{H}}_{ξ , 2} )}_{μ} ] {\tilde{x}}_{ξ} + {( {\tilde{w}}_{ξ} )}_{μ} , \qquad ( 8 )$$

where ξ=1, 2, . . . , N/4, α=2ξ−1 and β=2ξ. Since the columns of (\tilde{H}_{ξ})_{μ} are orthogonal, single symbol ML decoding can be applied and for each (v)_{μ} realization. In this case, the ML decoder then computes the following metrics as:

$$Δ ( μ ) = {\sum }_{ξ = 1}^{N / 4} ( {min}_{{x}_{α}} {‖ {( {\tilde{y}}_{ξ} )}_{μ} - {( {\tilde{H}}_{ξ , 1} )}_{μ} {\tilde{x}}_{α} ‖}^{2} + {min}_{{x}_{β}} {‖ {( {\tilde{y}}_{ξ} )}_{μ} - {( {\tilde{H}}_{ξ , 2} )}_{μ} {\tilde{x}}_{β} ‖}^{2} ) , \qquad ( 9 )$$

where \tilde{x}_{γ}=[x_{γ}^{(H,R)}, x_{γ}^{(H,I)}, x_{γ}^{(L,R)}, x_{γ}^{(L,I)}}^{T}. Here, firstly, the activated SAP (v)_{\hat{μ}} a is determined by using

$$\hat{μ} = arg {min}_{μ} Δ ( μ ) .$$

This may be performed by SAP detector 362 shown in FIG. 3b. Then, data symbols are decoded by using the following rules:

$${\hat{x}}_{α} = {min}_{{x}_{α}} {‖ {( {\tilde{y}}_{ξ} )}_{\hat{μ}} - {( {\tilde{H}}_{ξ , 1} )}_{\hat{μ}} {\tilde{x}}_{α} ‖}^{2} {\hat{x}}_{β} = {min}_{{x}_{β}} {‖ {( {\tilde{y}}_{ξ} )}_{\hat{μ}} - {( {\tilde{H}}_{ξ , 2} )}_{\hat{μ}} {\tilde{x}}_{β} ‖}^{2} . \qquad ( 10 )$$

The data symbol decoding may be performed by symbol detector 361 in FIG. 3b. The same process is performed to detect the SAPs, (v)_{\hat{μ}}_{₁}, . . . , (v)_{\hat{μ}}_{_{G}}, and the data symbols, \hat{x}1, . . . , \hat{x}_{G}, of all subblocks, \hat{x}=[\hat{x}₁, . . . , \hat{x}_{N/2}]^{T}. As a result of the single-symbol ML detection, the number of metrics calculated for the decoding decreases from NM^{N/2} to (N/2)NM.

FIG. 3b shows an exemplary implementation of a receiver 360, which determines the data from the component-interleaved symbols, which have been generated by the CI-PIM on the transmitter sides as described above. Similar to the transmitter 350 of FIG. 3a, the receiver 360 is an example of an OFDM receiver, i.e. a receiver where the receiver signals are OFDM signals and hence have a OFDM waveform. However, the receiver is not limited to an OFDM receiver, but may receive signals having non-orthogonal waveforms (non-OFDM) and being signals modulated by the CI-PIM of the present disclosure. The one or more component interleaved symbols may be received via a single antenna 366. Same reception may be performed with multiple antennas. Since the received symbols are still in time domain, frequency-domain signals may be generated by fast Fourier transform after the CP removal. The CP removal and the FFT processing may be performed by a single unit such the remove CP and FFT unit 365. Alternatively, the CP removal and the FFT may be performed separately, i.e. by separate functional blocks for CP removal and FFT. The frequency-domain signal carrying the data (i.e. the data and the carrier indices) area then deinterleaved by deinterleaver 364 to obtain the still encoded data for each group g=1, . . . , G. The OFDM block splitter 363 splits the encoded data into G frequency-domain reception signals y=[y₁, . . . , y_{G}], as illustrated in FIG. 3b. Then, for each signal yᵢ with i=1, . . . ,G, the respective data \hat{x}ᵢ for each group is determined. As FIG. 3b shows, the detection of the data may be performed independently for each group, allowing for an efficient parallel symbol detection. With reference to the discussion above, the activated SAP (v)_{\hat{μ}} is first determined by SAP detector 362, which uses the respective y; as input. Each SAP detector provides for its input signal yᵢ a respective index \hat{μ}ᵢ for the SAP. The SAP index \hat{μ}ᵢ and signal yᵢ is then input to symbol detector 361, which decodes the data for each group.

The receiver 360 performing the functions as described my be the general receiver of FIG. 1 or the receiving device 260 of FIG. 2b. For example, antenna 366 may be part of the wireless transceiver 263. Alternatively, antenna 366 may be separate and connected to the transceiver 263 via a COAX cable. The units remove CP and FFT 365, deinterleaver 364, OFDM block splitter 363, the one or more SAP detectors 362, and the one or more symbol detectors 361 may be included in the processing circuitry 262 of receiving device 260. Alternatively, any of the functional blocks (i.e. units) 361 to 365 may be a separate unit of the receiving device 260. In this case, any of the respective separate unit 361 to 365 may then communicate with the processing circuitry 262 such that the receiving device 260 performs all the functions for receiving and processing CI-PIM modulated signals and for detecting the data from the component-interleaved symbols (i.e. the CI-PIM modulated signals).

FIG. 7b illustrates an exemplary receiver 760 for OFDM, representing structural units (i.e. functional units) which may be included in the general receiver Rx of FIG. 1 or in the receiving device 260 of FIG. 2a. The receiver 760 is compatible with the transmitter 750 described above with reference to FIG. 7a. A signal is received via an antenna 867 and transformed from analog to digital domain by an analog to digital conversion module 866. Then, the digital symbols are parallelized in a serial to parallel conversion module 865. Cyclic prefix is removed in a CP module 864. Then, the transformation is performed in module 863. In this example, corresponding to FIG. 7a, the transformation is the FFT. After the FFT, the demodulation 862 is performed. The demodulation may include de-mapping from the subcarriers and some detection algorithm, as described above. The demodulation may be any of the above described embodiments and exemplary implementations. In particular, demodulator 762 may perform parts of the functions of the receiver 360 in FIG. 3b, including functional blocks to detect the data symbols from the component-interleaved symbols. This may include the deinterleaver 364, OFDM block splitter 363, the one or more SAP detectors 362, and the one or more symbol detectors 361. It is noted that, for example, the deinterleaver 364 may be a functional block on its own within the receiver 760 in FIG. 7b, and may be placed before demodulator 762. In other words, parts of the functional units of receiver 360 of FIG. 3b may be easily embedded into common OFDM receiver architecture, such as the one shown in FIG. 7b. After the demodulation 862, a parallel to serial module 861 serializes the demodulated bits into a data, which may be further processed. For example, forward error correction decoding, error detection or the like may be performed.

Regarding advantages, the application of the CI-PIM employing the smart bits-to-subblock mapping approach on the transmitter side as described above, the present disclosure can provide the desired diversity order larger than 2, which may be an important parameter in emerging and future wireless communication networks. The present disclosure benefits from coordinate interleaving and index modulation methods to exhibit a superior error performance. The CI-PIM modulation of the present disclosure can be used in existing and future wireless communication standards where high reliable data transmission is required, and high data rate is not a priority. Many wireless communication standards include the OFDM multicarrier waveform for data transmission. Since the present disclosure may preferably implemented in the OFDM scheme, it is compatible with all these standards. Hence, the present disclosure can be used in any wireless communication system that is based on OFDM transmission. Additionally, it can be implemented in devices, that are able to perform data transfer over wireless channel, such as cell phones, base stations, routers, computers, smart TVs, wireless sensor networks, etc. This can lead future research areas based on ultra-reliable waveform design.

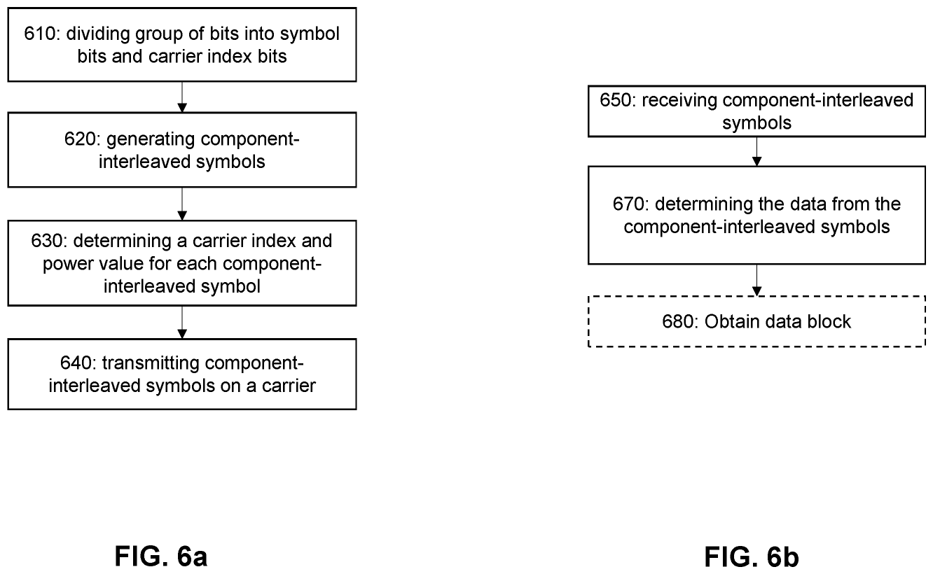

In correspondence with the above described transmitting device and receiving device, communication methods for wireless transmission(s) to be performed by a transmitting device and a receiving device is provided. As illustrated in FIG. 6a, the transmitting method for wireless transmission of data comprises dividing 610 a group of bits representing the data into symbol bits and carrier index bits. Such data is for instance bits representing the encoded data, such as FEC-encoded data. Such data may be further represented as modulation symbols of a modulation with order 2 (such as BPSK) or 4 (such as QPSK) or higher (e.g. nPSK modulations or nQAM modulations). In general, modulation symbols are complex symbols.

The method may further include generating 620 one or more component-interleaved symbols that correspond to complex symbols that are obtained by sequentially forming real and imaginary components of intermediate symbols out of said symbol bits; and interleaving said real and/or imaginary components among the intermediate symbols. The intermediate symbols may be rotated by applying a phase value. The phase value may be different for each of the intermediate symbols. The method may further include determining 630 a carrier index and a power value for each of the one or more component-interleaved symbols based on the carrier index bits. This corresponds to CI-PIM where coordinate interleaving is combined with power index modulation in that carrier index bits are exploited to determine a carrier index and a power value for each of the component-interleaved symbols.

Finally, each of the one or more component-interleaved symbols is transmitted 640 on a respective carrier given by the determined carrier index and with the determined power value. Each of the component-interleaved symbols may be transmitted at least with two different power values among a predefined set of power values, with the predefined set including a first power value and a second power value lower than the first power value. The determined power value may be a value among the predefined set and the determined carrier index is associated with one power values of the predefined set.

The transmission here may include various different steps. For example, after the mapping onto the subcarriers, an IFFT may be employed to generate frequency division multiplex symbols (such as OFDM symbols or symbols generated in a non-orthogonal frequency division scheme, or the like. Any system which maps modulation symbols onto different subcarriers may be applied. Peak-to-average power ratio (PAPR) reducing techniques may be applied, cyclic prefix (CP) may be included between the symbols, beamforming or space-time block coding or other form or spatial diversity may be added by any of the known techniques. Moreover, the waveforming and amplification may be applied. These steps are only exemplary, there may be additional steps and not all the above mentioned steps need to be applied (such as PAPR reduction), as is clear to those skilled in the art.

In correspondence with the above described receiving device, a communication method for wireless reception to be performed by a receiving device is provided. As illustrated in FIG. 6b, the method comprises receiving 650 each of one or more component-interleaved symbols on a respective carrier given by a determined carrier index and with a determined power value. Then, the data may be determined 670 from the one or more component-interleaved symbols by a predefined detection method. The predefined detection method may be maximum likelihood detection. Further, the predefined detection method may be independently applied on each of the one or more component-interleaved symbols, so as to individually detect the one or more component-interleaved symbols. Finally, the data may be obtained 680.

The CI-PIM modulation as described above may provide the following advantages:
a diversity order larger than 2 may be provided.
a better error performance than classical OFDM and several OFDM-IM based schemes may be provided.
the CI-PIM modulation processing may be simply implemented in OFDM-based wireless communication systems, such as LTE and IEEE 802.11 family. Hence, no special OFDM architecture needs to be exploited, reducing cost of the OFDM transmitter-receiver system.
an ultra-reliable data transmission and reception is provided.
a desirable diversity order, i.e. a variable diversity order may be provided.

In the following, further details are provided to obtain an upper bound on the BER of CI-OFDM-PIM system under the assumption of ML detection. As known in the literature, average bit error probability (ABEP) of CI-PIM can be obtained as:

$${P}_{b} = \frac{1}{p {2}^{p}} {\sum }_{c , \hat{c}} P ( c \to \hat{c} ) e ( c , \hat{c} ) , \qquad ( 11 )$$

where e(c,ĉ) is the number of erroneous bits when c is transmitted. However, c is incorrectly detected and P(c→ĉ) is the pairwise error event for the corresponding pairwise event and given by

$$P ( c \to \hat{c} ) \approx \frac{1 / 4}{det ( {I}_{N} + ( Γ / 3 ) D )} + \frac{1 / 12}{det ( {I}_{N} + ( Γ / 4 ) D )} , \qquad ( 12 )$$

where I_{N} and D=(c−ĉ)^{H}(c−ĉ) are N×N identity matrix and difference matrix, respectively.

In order to investigate the diversity order of CI-PIM, two cases are considered: (1) detecting index bits erroneously and (2) detecting single or multiple data symbols under the condition of detecting index bits correctly. For case (1), it is assumed that p₂=[00], v=[1,2,3,4]^{T}, bits are transmitted. Nonetheless, bits, \hat{v}=[4,1,2,3]^{T}, are decoded incorrectly from above Table 1. As seen from this example, the Hamming distance between v and \hat{v} is N=4. This result for the Hamming distance is valid for all other pairwise (v,\hat{v}) events. Consequently, the diversity order is always 4 for case (1). For case (2), it is assumed that c with data symbols (x̅₁,x₂), is transmitted, and ĉ with (x̅₁,\overline{\hat{x}}₂), is decoded erroneously with a single symbol error (x̅₂→\overline{\hat{x}}2). This pair (c, ĉ) is given as:

$$c = {[ {( {\overline{x}}_{1}^{R} + j {\overline{x}}_{2}^{I} )}^{H} , {( {\overline{x}}_{2}^{R} + j {\overline{x}}_{1}^{I} )}^{H} , {( {\overline{x}}_{1}^{R} + j {\overline{x}}_{2}^{I} )}^{L} , {( {\overline{x}}_{2}^{R} + j {\overline{x}}_{1}^{I} )}^{L} ]}^{T} \hat{c} = {[ {( {\overline{x}}_{1}^{R} + j {\hat{\overline{x}}}_{2}^{I} )}^{H} , {( {\hat{\overline{x}}}_{2}^{R} + j {\overline{x}}_{1}^{I} )}^{H} , {( {\overline{x}}_{1}^{R} + j {\hat{\overline{x}}}_{2}^{I} )}^{L} , {( {\hat{\overline{x}}}_{2}^{R} + j {\overline{x}}_{1}^{I} )}^{L} ]}^{T} . \qquad ( 13 )$$

As seen from equation (13), only one symbol error causes changes over all subcarriers, and hence results in a diversity order of r=N=4, where r=rank(D). Consequently, when non-zero and different rotation angles [θ₁, . . . , θ_{N/2}] are selected, min_{C,Ĉ}(r)=4, demonstrating that the approach of the present disclosure may provide a diversity order of 4.

The rotation angles θ and power levels (P_{H},P_{L}) affect the non-zero eigenvalues of D being λ_{ζ}, ζ=1, 2, . . . , N, and as a consequence the ABEP. For simplicity, a single power level P is defined, with 0<P<1, and rotation angle θ, where P_{H}=2−P, P_{L}=P. θₙ is calculated with respect to θ as discussed in the following for n=1, . . . , N/2. Considered is the worst case of pairwise error probability (PEP) events to obtain the optimum θ and P values as:

$$( {θ}_{opt} , {P}_{opt} ) = arg {max}_{θ , P} {δ}_{min} . \qquad ( 14 )$$

Here, δₘᵢₙ=min_{c,ĉ}Π_{ζ=1}^{N}λ_{ζ} is the MCGD, which is a significant parameter for the minimization of the ABEP in equation (11). Since a joint search over all possible values of P and θₙ is not practically feasible, a heuristic approach is used providing a near-optimal solution to find θₒₚₜ and Pₒₚₜ as follows. Since quadrature amplitude modulation (QAM) constellation repeats itself every 90°, the 90° is divided into N/2 parts. In this case, the nth rotation angle is defined as θₙ=θ+180(n−1)/N, 0<θ<90/N, n=1, . . . , N/2. Optimal values for (θₒₚₜ,Pₒₚₜ) can be obtained by exhaustive search as (8.5°, 0.45) and (8°, 0.40) for 4-QAM and 8-QAM, respectively, when N=4 by plotting the MCGD variation with respect to P and θ using step sizes of (0.5,0.05) for (θₒₚₜ,Pₒₚₜ).

For higher values of M and N, carrying out an exhaustive search over all possible (c, ĉ) pairs is not practical. In this case, δₘᵢₙ is evaluated for c∈{c¹} and ĉ∈{c¹,c²}, where c¹=diag([s₁^{H},s₂^{H},s₁^{L},s₂^{L}]^{T}) and c²=diag([s₁^{L},s₂^{L},s₁^{H},s₂^{H}]^{T}) are baseline worst case error events for N=4. Here, two PEP events are considered: i) (c¹→c¹): correct SAP with single erroneous data symbol, ii) (c¹→c²): detecting SAP as N/2 circularly shifted version of it with correct or erroneous data symbols.

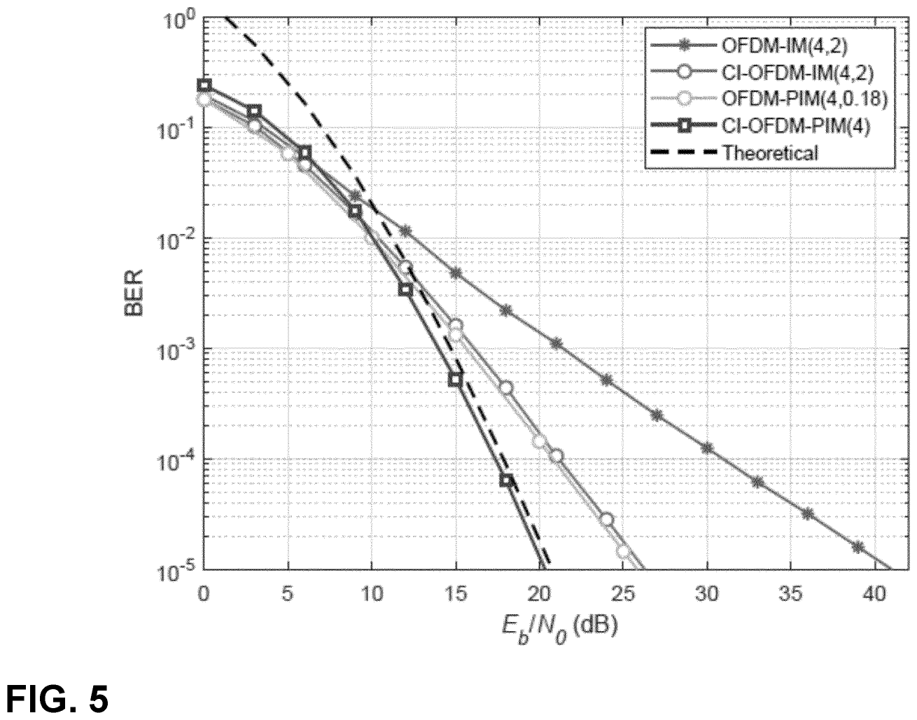

In order to assess the capabilities of the of improving the BER, FIG. 5 shows a comparison of simulated BER versus signal-to-noise ratio E_{b}/E₀ for benchmarking the CI-PIM approach of the present disclosure with other known schemes. For the benchmark, it is assumed that the system parameters are a number of S=128 subcarriers, S_{CP}=16, and T=10 tap Rayleigh channel whose elements are uniformly distributed, S_{CP} being the length of cyclic prefix (here exemplarily in units of time domain samples). Moreover, the simulated system is OFDM. For convenience, the following notation is used:
“OFDM-IM (N, v)” is used referring to an OFDM-IM scheme where v out of N subcarriers are active.
“DM-OFDM (N, v)” refers to a DM-OFDM scheme where v out of N subcarriers exploit the primary M-ary PSK (or QAM) constellations.
“SuM-OFDM-IM (M, Q)” refers to a SuM-OFDM-IM scheme with Q symbols included in each M mode.
“CI-OFDM-IM (N, v)” refers to a CI-OFDM-IM scheme with v out of N subcarriers are active.
“OFDM-PIM (N, P)” refers to an OFDM-PIM scheme with N subcarriers and optimum power of P.
“RC-OFDM (n)” refers to a RC-OFDM scheme with a repetition rate of n.
“CI-OFDM-PIM (N)” refers to the CI-PIM scheme of the present disclosure, with subblock length N. The optimum angle and power level for the CI-OFDM-PIM are determined based on the selection strategy discussed above.

As may be discerned from FIG. 5, the theoretical BER curve (long-dashed line), which is obtained by equation (10), defines an upper bound for CI-PIM. Furthermore, CI-PIM provides approximately a 6 dB gain over CI-OFDM-IM and OFDM-PIM as a result of enabling a higher diversity gain at a BER value of 10-5 when N=4, M=4, with the spectral efficiency being 1.5 bps/Hz (unit “bps”: bits per second and “Hz”: frequency in Hertz).

Embodiments of the present disclosure may be particularly suitable for Wi-Fi standards, including IEEE 802.11ax, 5G, and 6G etc., For example, as mentioned above, in IEEE 802.11ax CI-PIM could be part of some modulation and coding schemes (MCSO). In future standards, such as 802.11be there may be further MCSs which support CI-PIM. Application of the above discussed CI-PIM modulation may provide an additional MCSs, wherein it may be advantageous to apply these robust techniques for the lower MCSs (MCSs for lower SNRs), as they may increase diversity and lower the error rate. Accordingly, it may be desirable to apply lower-order modulation(s) to the symbols, mapped according to the CI-PIM in such additional MCS or MCSs. For example, a binary phase shift keying (BPSK) may be applied (possibly with rotation) in some embodiments. In some implementations, QPSK may be applied. Coding applied with these modulations may have e.g. a code rate of ½ or the like. However, as mentioned, the present disclosure is not limited to the WiFi framework and in general also applicable with higher level modulations and other code rates.

In context of WiFi, CI-PIM may be applied, e.g. to 40, 80, or 160 symbols so that 80, 160, or 320 RUs are used. However, these are mere examples. In order to increase diversity, CI-PIM as described above may be advantageously applied. Following the subcarrier mapping, some PAPR reduction scheme may be applied.

The methodologies described herein (at the transmitter side and the received side) may be implemented by various means depending upon the application. For example, these methodologies may be implemented in hardware, operation system, firmware, software, or any combination of two or all of them. For a hardware implementation, any processing circuitry may be used, which may include one or more processors. For example, the hardware may include one or more of application specific integrated circuits (ASICs), digital signal processors (DSPs), digital signal processing devices (DSPDs), programmable logic devices (PLDs), field programmable gate arrays (FPGAs), processors, controllers, any electronic devices, or other electronic circuitry units or elements designed to perform the functions described above.

If implemented as program code, the functions performed by the transmitting apparatus (device) may be stored as one or more instructions or code on a non-transitory computer readable storage medium such as the memory 310 or any other type of storage. The computer-readable media includes physical computer storage media, which may be any available medium that can be accessed by the computer, or, in general by the processing circuitry 320. Such computer-readable media may comprise RAM, ROM, EEPROM, optical disk storage, magnetic disk storage, semiconductor storage, or other storage devices. Some particular and non-limiting examples include compact disc (CD), CD-ROM, laser disc, optical disc, digital versatile disc (DVD), Blu-ray (BD) disc or the like. Combinations of different storage media are also possible—in other words, distributed and heterogeneous storage may be employed.

For example, the program code may cause the processing circuitry 252 and/or processing circuitry 262 (e.g. including one or more processors) to operate as a special purpose computer programmed to perform the techniques disclosed herein. The program code is stored on a non-transitory and computer readable medium, such as the memory 251 and/or memory 261. In particular, storing program code for transmitting data as described herein may be stored on memory 251, while program code for receiving data as described herein may be stored on memory 261. Alternatively, program code for transmitting and receiving data may be stored on memory 251 and/or memory 261, respectively.

The embodiments and exemplary implementations mentioned above show some non-limiting examples. It is understood that various modifications may be made without departing from the disclosed subject matter. For example, modifications may be made to adapt the examples to new systems and scenarios without departing from the central concept described herein. In particular, the above embodiments and exemplary implementations are multiple-input multiple-output (MIMO) compatible and can be applied to all MCSs.

According to an aspect, a method is provided for wireless transmission of data, the method comprising the steps of: dividing a group of bits representing the data into symbol bits and carrier index bits; generating one or more component-interleaved symbols that correspond to complex symbols that are obtained by sequentially forming real and imaginary components of intermediate symbols out of said symbol bits; and interleaving said real and/or imaginary components among the intermediate symbols; determining a carrier index and a power value for each of the one or more component-interleaved symbols based on the carrier index bits; and transmitting each of the one or more component-interleaved symbols on a respective carrier given by the determined carrier index and with the determined power value.

In some exemplary implementations, the generating of the one or more component-interleaved symbols includes rotating the one or more intermediate symbols by applying a phase value. According to a preferred implementation, the phase value is different for each of the one or more intermediate symbols.

For example, each of the one or more component-interleaved symbols is transmitted at least with two different power values among a predefined set of power values including a first power value and a second power value being lower than the first power value. Further, the determined power value is a value among the predefined set of power values and the determined carrier index is associated with one power value of the predefined set.

In a further implementation example, the carrier index bits encode the carrier indices sequentially according to decreasing values of the power values of the predefined set.

According to an embodiment, the group of bits is an integer number of p bits divided into p=p₁+p₂, wherein p₁ is the number of the symbol bits given by

$${p}_{1} = ( \frac{N}{2} ) {log}_{2} ( M ) ;$$

and p₂ is the number of the carrier index bits given by p₂=log₂(N), with N referring to a length of a data block corresponding to the data, N being an even integer larger than two and M being the modulation order, and N and M being given by 2 power to an integer larger than 0.

According to an aspect, a method is provided for wireless reception of data, the method comprising the steps of: receiving each of one or more component-interleaved symbols on a respective carrier given by a determined carrier index and with a determined power value, wherein the data is represented by a group of bits divided into symbol bits and carrier index bits; and the one or more component-interleaved symbols that correspond to complex symbols are obtained by: sequentially forming real and imaginary components of intermediate symbols out of said symbol bits; and interleaving said real and/or imaginary components among the intermediate symbols; wherein the carrier index and the power value being determined for each of the one or more component-interleaved symbols based on the carrier index bits; and determining the data from the one or more component-interleaved symbols by a predefined detection method.

For example, the predefined detection method is maximum likelihood, ML, detection on the one or more component-interleaved symbols. In a preferred implementation, the predefined detection method is independently applied on each of the one or more component-interleaved symbols so as to individually detect the one or more component-interleaved symbols.

The above described modulation details also apply to the receiving method, as the receiving method processes the signal as transmitted by the transmitter.

According to an aspect, an apparatus is provided for wireless transmission of data, comprising: a circuitry configured to: divide a group of bits representing the data into symbol bits and carrier index bits; generate one or more component-interleaved symbols that correspond to complex symbols that are obtained by sequentially forming real and imaginary components of intermediate symbols out of said symbol bits and interleaving said real and/or imaginary components among the intermediate symbols; determine a carrier index and a power value for each of the one or more component-interleaved symbols based on the carrier index bits; and a transceiver configured to transmit each of the one or more component-interleaved symbols on a respective carrier given by the determined carrier index and with the determined power value.

According to an aspect, an apparatus is provided for wireless reception of data, comprising: a transceiver configured to receive each of one or more component-interleaved symbols on a respective carrier given by a determined carrier index and with a determined power value, wherein the data is represented by a group of bits divided into symbol bits and carrier index bits; and the one or more component-interleaved symbols that correspond to complex symbols are obtained by: sequentially forming real and imaginary components of intermediate symbols out of said symbol bits; and interleaving said real and/or imaginary components among the intermediate symbols; wherein the carrier index and the power value being determined for each of the one or more component-interleaved symbols based on the carrier index bits; and a circuitry configured to determine the data from the one or more component-interleaved symbols.

The examples and exemplary implementations described above for the methods apply in the same manner to the apparatuses. In particular, the processing circuitry may be further configured to perform the steps of one or more of the above-described embodiments and exemplary implementations.

Still further, a computer program is provided, stored on a non-transitory and computer-readable medium, wherein the computer program includes instructions which when executed on one or more processors or by a processing circuitry perform steps of any of the above-mentioned methods.

According to some embodiments, the processing circuitry and/or the transceiver is embedded in an integrated circuit, IC.

Although the disclosed subject matter has been described in detail for the purpose of illustration based on what is currently considered to be the most practical and preferred embodiments, it is to be understood that such detail is solely for that purpose and that the disclosed subject matter is not limited to the disclosed embodiments, but, on the contrary, is intended to cover modifications and equivalent arrangements that are within the spirit and scope of the appended claims. For example, it is to be understood that the presently disclosed subject matter contemplates that, to the extent possible, one or more features of any embodiment can be combined with one or more features of any other embodiment.

1. A method for wireless transmission of data, the method comprising the steps of:
dividing a group of bits representing the data into symbol bits and carrier index bits;
generating one or more component-interleaved symbols that correspond to complex symbols that are obtained by
sequentially forming real and imaginary components of intermediate symbols out of said symbol bits; and
interleaving said real and/or imaginary components among the intermediate symbols;
determining a carrier index and a power value for each of the one or more component-interleaved symbols based on the carrier index bits; and
transmitting each of the one or more component-interleaved symbols on a respective carrier given by the determined carrier index and with the determined power value.

2. The method according to claim 1, wherein
each of the one or more component-interleaved symbols is transmitted at least with two different power values among a predefined set of power values comprising a first power value and a second power value being lower than the first power value.

3. The method according to claim 1, wherein the determined power value is a value among the predefined set of power values and the determined carrier index is associated with one power value of the predefined set.

4. The method according to claim 1, wherein
the carrier index bits encode the carrier indices sequentially according to decreasing values of the power values of the predefined set.

5. The method according to claim 1, wherein
the generating of the one or more component-interleaved symbols comprises rotating the one or more intermediate symbols by applying a phase value.

6. The method according to claim 5, wherein
the phase value is different for each of the one or more intermediate symbols.

7. The method according to claim 1, wherein
the group of bits is an integer number of p bits divided into p=p₁+p₂, wherein
p₁ is the number of the symbol bits given by
$${p}_{1} = ( \frac{N}{2} ) {log}_{2} ( M ) ;$$
and
p₂ is the number of the carrier index bits given by p₂=log₂(N),
with N referring to a length of a data block corresponding to the data, N being an even integer larger than two and M being the modulation order, and N and M being given by 2 power to an integer larger than 0.

8. A method for wireless reception of data, the method comprising the steps of:
receiving each of one or more component-interleaved symbols on a respective carrier given by a determined carrier index and with a determined power value, wherein
the data is represented by a group of bits divided into symbol bits and carrier index bits; and
the one or more component-interleaved symbols that correspond to complex symbols are obtained by:
sequentially forming real and imaginary components of intermediate symbols out of said symbol bits; and
interleaving said real and/or imaginary components among the intermediate symbols;
wherein the carrier index and the power value being determined for each of the one or more component-interleaved symbols based on the carrier index bits; and
determining the data from the one or more component-interleaved symbols by a predefined detection method.

9. The method according to claim 8, wherein
the predefined detection method is maximum likelihood, ML, detection on the one or more component-interleaved symbols.

10. The method according to claim 8, wherein
the predefined detection method is independently applied on each of the one or more component-interleaved symbols so as to individually detect the one or more component-interleaved symbols.

11. At least one non-transitory, computer readable medium, including program code that, when executed by at least one processor, causes the at least one processor to perform the method of claim 1.

12. An apparatus for wireless transmission of data, comprising:
a circuitry configured to:
divide a group of bits representing the data into symbol bits and carrier index bits;
generate one or more component-interleaved symbols that correspond to complex symbols that are obtained by
sequentially forming real and imaginary components of intermediate symbols out of said symbol bits and
interleaving said real and/or imaginary components among the intermediate symbols;
determine a carrier index and a power value for each of the one or more component-interleaved symbols based on the carrier index bits; and
a transceiver configured to transmit each of the one or more component-interleaved symbols on a respective carrier given by the determined carrier index and with the determined power value.

13. An apparatus for wireless reception of data, comprising:
a transceiver configured to receive each of one or more component-interleaved symbols on a respective carrier given by a determined carrier index and with a determined power value, wherein
the data is represented by a group of bits divided into symbol bits and carrier index bits; and
the one or more component-interleaved symbols that correspond to complex symbols are obtained by:
sequentially forming real and imaginary components of intermediate symbols out of said symbol bits; and
interleaving said real and/or imaginary components among the intermediate symbols;
wherein the carrier index and the power value being determined for each of the one or more component-interleaved symbols based on the carrier index bits; and
a circuitry configured to determine the data from the one or more component-interleaved symbols.
